(19) United States
(12) Patent Application Publication
(10) Pub. No.: US 2021/0276040 A1
(43) Pub. Date: Sep. 9, 2021

(54) METHOD AND APPARATUS FOR FLAME COATING TUBULAR ELEMENTS WITH THERMOPLASTIC POWDERS

(71) Applicant: IBIX S.R.L., LUGO (IT)

(72) Inventor: Susanna GIOVANNINI, LUGO (IT)

(21) Appl. No.: 17/261,376

(22) PCT Filed: Jul. 19, 2019
(86) PCT No.: PCT/IT2019/050169

§ 371 Date: Jan. 19, 2021

(30) Foreign Application Priority Data
Aug. 7, 2018 (IT) 102018000007939

(51) Int. Cl. B05D 1/10; B05B 7/20; B05B 13/04; B05D 3/08

(52) U.S. Cl. CPC B05D 1/10; B05B 7/206; B05B 13/041; B05D 3/08; B05B 13/0436; B05B 13/0442; B05B 13/0431

(57) ABSTRACT

The method for flame coating tubular elements provides for arranging a said tubular element (2) to be coated at a coating station, providing an applicator unit (3), operating in the coating station, in an inactive configuration, spaced from the tubular element (2), the applicator unit (3) carrying at least one thermoplastic powders flame applicator device (4) and being alternatively operable between the inactive configuration and an active configuration, approached radially to the tubular element (2). After having brought the applicator unit (3) towards the tubular element (2), the method provides for operating the same unit (3) in the active configuration, so as to peripherally engage the element (2) itself. The applicator device (4) is turned on, the thermoplastic powders are fed and the applicator device (4) is operated in motion around and/or along the tubular element (2) so as to flame coating it with a controlled flow of thermoplastic powders.

### TECHNICAL FIELD

The present invention relates to a method and an apparatus for flame coating tubular elements with thermoplastic powders, in particular joints and curved tubular elements.

### PRIOR ART

The technique of flame spray painting of thermoplastic powders applied by fusion has long been known. This technique is used for example for making anticorrosive coatings on manufactured articles of different nature.

According to a known method, the thermoplastic powders are sprayed onto the product to be coated by means of an applicator gun fed with compressed air and with a suitable liquefied petroleum gas. The gas flame produced by the applicator gun transfers the fused particles of the powder onto the product to be coated.

The method of painting by means of flame spraying is of rapid and economical use and is suitable for painting different materials. However, the apparatuses currently used to make such painting have certain drawbacks, which limit their performance and therefore make the use of the aforementioned method less effective.

In particular, the need is felt, especially in the field of tube coatings, joints and curved tubular elements, to render coating processes faster, repeatable and reliable.

Currently, in fact, the coating of these types of products takes place mainly manually, through use of the aforementioned spraying apparatuses, by expert personnel.

Machines for automatic tube coating have also been developed. For example, EP 2 977 111 illustrates a machine capable of heating a portion of a tube through induction means and coating it.

However, machines of the known type are not exempt from improvements.

### DISCLOSURE

The aim of the present invention is to solve the aforementioned problems, devising a method and an apparatus for flame coating tubular elements with thermoplastic powders, capable of quickly and effectively coating such elements.

Within this aim, a further object of the present invention is to provide an apparatus for flame coating tubular elements with thermoplastic powders, which makes the thermoplastic coating operations much easier for the operator, faster and with repeatable and better results.

A further object of the invention is to provide an apparatus for flame coating tubular elements with thermoplastic powders, which is of simple constructive and functional conception, surely reliable, versatile in use, and relatively inexpensive.

The aforementioned objects are achieved, according to the present invention, by the method and apparatus for flame coating tubular elements with thermoplastic powders according to claims 1 and 8, respectively.

The method according to the invention, in particular, provides for arranging a tubular element to be coated at a coating station, at which an applicator unit is operative, alternatively operable between an inactive configuration, which is spaced from the tubular element to be coated, and an active configuration, approached radially to the same element, when the latter is arranged along a longitudinal axis at the aforesaid coating station.

The method provides for initially arranging the applicator unit in inactive configuration, and putting it near to the same tubular element in active configuration.

The method then involves switching at least one thermoplastic powders flame applicator device, carried by the applicator unit, feeding the aforesaid powders to the aforesaid applicator device and thus coating the tubular element by actuating the same device along and around the aforementioned longitudinal axis, making on it a coating layer with the fed thermoplastic powders.

Preferably, the thermoplastic powders are polypropylene or polyethylene powders.

Similarly, the present invention illustrates an apparatus capable of implementing the aforementioned method.

The apparatus comprises in particular the aforementioned applicator unit, capable of moving one and more thermoplastic powders flame applicator devices along and around the aforementioned longitudinal axis.

The applicator unit, in particular, can be operated in the aforementioned active configuration, at which at least one applicator device carried by the assembly itself, preferably a plurality, in particular, four applicator devices, can be arranged around the outer surface of the tubular element to be coated, arranged at the aforesaid coating station.

In this way it is possible to automatically perform the coating of the tubular element, with a controlled flow of thermoplastic powders.

Advantageously, the apparatus does not include induction heating means.

The aforementioned applicator devices can be operated with controlled speed around and/or along the aforementioned longitudinal axis, at the same time regulating the thickness and uniformity of the coating layer during the implementation phase.

Advantageously, means for detecting the temperature and/or the thickness of the coating, associated with the applicator unit may be provided, to control the process in the execution phase and thus obtain repeatable results.

Preferably, the aforementioned sector can carry at least one further applicator device.

Preferably the aforementioned applicator devices are distributed radially around the longitudinal axis in the aforementioned active configuration.

According to a particular aspect of the invention the aforesaid temperature detecting means are infrared.

According to a particular aspect of the invention the aforementioned means for detecting the thickness of produced coating layer are of the laser type.

A particular solution according to the invention provides for the apparatus to comprise a first sector and a second sector, each carrying at least one respective applicator device.

According to this solution, the aforementioned first sector and the aforementioned second sector are mutually hinged so as to rotate reciprocally around a respective hinging axis between the aforementioned inactive, open configuration and the aforementioned active configuration, closed in a loop around the longitudinal axis.

According to a particular aspect, at least one of the first sector and the second sector preferably has a motor member, the motor member rotating the at least one applicator device by the interposition of a transmission means, for example toothed one.

Preferably the applicator unit is carried by a frame, which in turn carries a coupling portion for attachment to lifting means.

According to an alternative solution it is possible that the apparatus comprises a robotic arm carrying the aforementioned sector, the robotic arm being capable of different degrees of freedom, for example six in addition to one relating to the translational motion along the aforesaid longitudinal axis, for coating a curved tubular element around the aforesaid longitudinal axis.

### BRIEF DESCRIPTION OF DRAWINGS

The details of the invention will become more evident from the detailed description of a preferred embodiment of the apparatus for flame coating tubular elements with thermoplastic powders according to the invention, illustrated only by way of non-limitative example in the accompanying drawings, where:

FIGS. 1 and 2 respectively show a front view of the apparatus for flame coating tubular elements with thermoplastic powders according to the present invention, in a first and in a second operating configuration;

FIG. 3 shows a side view of the apparatus shown in FIG. 2;

FIG. 4 shows a schematic front view of a system in which the apparatus shown in FIGS. 1 to 3 is used;

FIGS. 5, 6 and 7 respectively show a side plan view, and a front view of a second embodiment of the apparatus according to the invention;

FIG. 8 shows an enlarged plan view of a detail of the apparatus illustrated in FIGS. 5 to 7;

FIGS. 9 and 10 show a front view of a detail of the second embodiment, in respective operating configurations.

### EMBODIMENTS OF THE INVENTION

With particular reference to these figures, the reference numeral 1 generally indicates the apparatus for flame coating tubular elements 2 with thermoplastic powders, in particular joints or similar products. The apparatus 1 is inserted inside a plant for the treatment of the aforesaid products, in which other apparatus can be provided for producing finished product.

The apparatus 1, in fact, is preferably intended to make a third coating layer on the tubular elements which, preferably, in the same plant or in another location, can be subjected to blasting beforehand, for the preparation of the surfaces to be treated, preheating to a suitable temperature, preferably in the range from 220 to 240° C., to the application of a first layer by fusion bonded epoxy FBE or as an alternative to the application of a liquid epoxy primer at a suitable pre-heating temperature, possibly together with polyethylene or polypropylene powders, and finally to the application of a second and possibly a third layer superimposed on the first one, preferably by spraying polypropylene or polyethylene powders.

The apparatus 1 therefore comprises an applicator unit 3 carrying at least one applicator device 4 for flame coating with thermoplastic powders.

In the case illustrated by way of example, the applicator unit 3 comprises four applicator devices 4, but this number could be different, provided it is fit for the purpose.

The applicator device 4 is preferably made up of a spray gun of the type illustrated in

EP3057713, and preferably provided with the automatic switching on system illustrated in EP3068546, both in the name of the same Applicant.

Preferably, the applicator device 4 is also provided with suitable control means, for example flame detector sensors, to ensure complete safety of the apparatus 1.

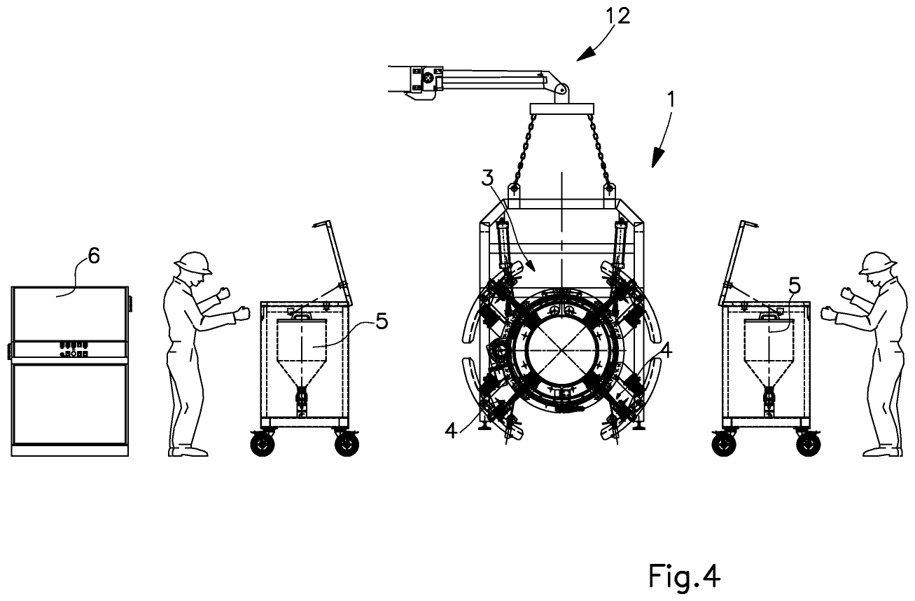

In particular, the apparatus 1 can furthermore comprise one or more feeding units 5 of the thermoplastic powders, for example a pair of feeding units 5, which control can be usefully carried out by a central control unit 6 or console of the apparatus 1 (see FIG. 4). For example, it may be advantageous to monitor the level of the powders by means of the control unit 6, through a special sensor means associated with the aforesaid feeding units 5, and to remotely adjust the mixing of the powders with the gases and air supplied to the spray gun 4, the relative pressure, as well as the flow rate and related fluid-dynamic parameters of the resulting flow.

The applicator unit 3 preferably comprises at least one sector 7, preferably a first sector 7 and a second sector 8, carrying at least one applicator device 4, intended to be operated in relative motion with respect to the tubular element 2, to make a uniform coating layer on it.

The first sector 7 and the second sector 8 have an arcuate arrangement, for example having a semi circumference shape, so as to adequately surround, in use, the tubular element 2.

The same sectors 7, 8 are carried by a frame 9, for example made up of a portal.

More precisely, the first sector 7 and the second sector 8 may be respectively made by means of an end portion 71, 81 and an opposite end portion 72, 82 reciprocally constrained by means of rods and longitudinal guides, as described in detail below.

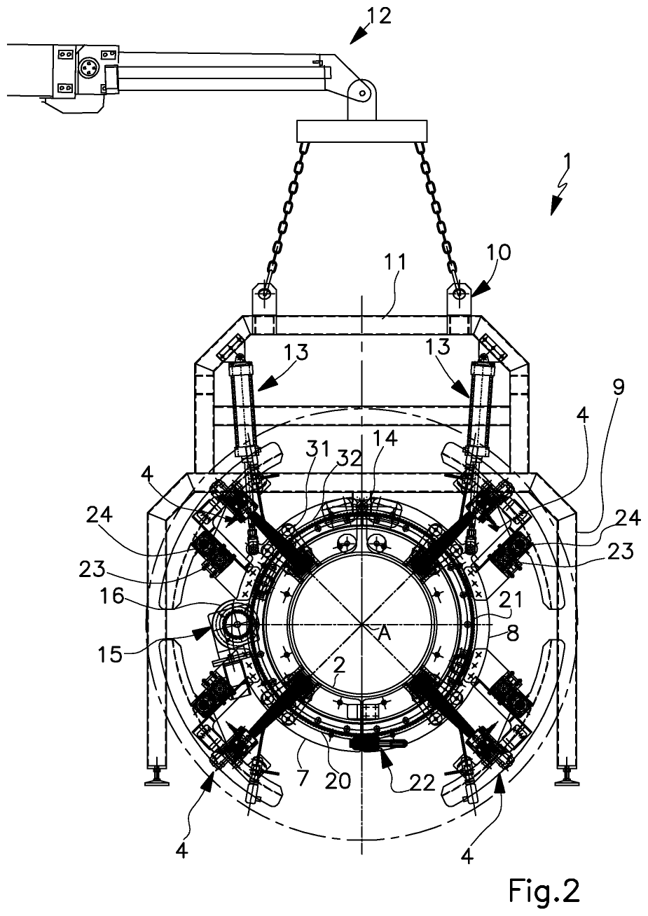

The frame 9 preferably comprises a hooking portion 10, for example at a top crosspiece 11, thanks to which it can be easily moved, for example by hooking to lifting means 12 of a known type (see FIG. 2).

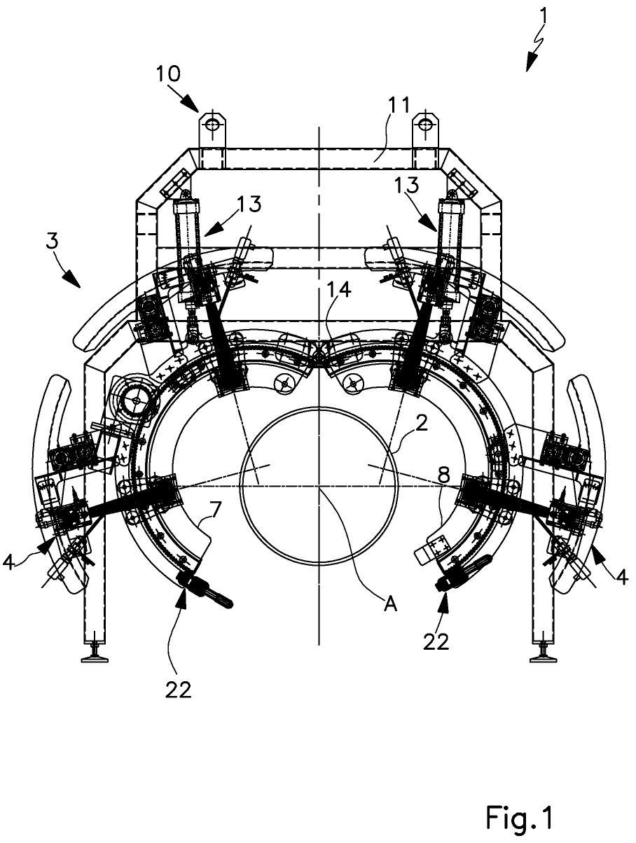

The frame 9 carrying the applicator unit 3 can therefore be moved to a plant coating station, at which the tubular element 2, for example a joint, can be arranged along a longitudinal axis A, as illustrated in FIG. 1.

The first sector 7 and the second sector 8 are alternatively operable, by means of a positioning device 13, for example comprising hydraulic or pneumatic jacks articulated to the frame 9 itself, on one side, and to a portion of the respective sector 7, 8 on the other, between an inactive configuration, spaced from the tubular element 2, and an active configuration, for engaging the outer surface of the tubular element 2 itself.

In practice, in the aforementioned active configuration each applicator device 4 is positioned around the tubular element 2, so as to be able to achieve the desired coating.

The first sector 7 and the second sector 8 are preferably hinged at a common hinging axis 14 fixed with respect to the frame 9 and, therefore, operable alternatively between the aforementioned inactive configuration, then open or spread, and the aforementioned active configuration, then closed in a ring.

More precisely, in the aforementioned active configuration, the first sector 7 and the second sector 8 are arranged in a ring, substantially with a circular profile, around the tubular element 2 arranged along the longitudinal axis A in the coating station (see FIG. 2).

The applicator unit 3 also preferably comprises drive means 15, suitable for moving the applicator devices 4 along the annular profile of the first sector 7 and of the second sector 8 in the closed configuration.

More precisely, the aforementioned driving means 15 of the applicator unit 3 can include a motor member 16 fixed to one of the first sector 7 and the second sector 8 and connected to transmission means 17, for example of the toothed type, such that the rotation of the applicator devices 4 is operated along the circular profile of the sectors 7, 8 arranged in the active configuration, then closed in a ring around the predisposed tubular element 2. In practice, the driving means 15 are configured to rotate the applicator devices 4 around the longitudinal axis A.

The transmission means 17 can include a gear wheel 18, keyed to the output shaft of the motor member 16, and engaged with a toothed ring 19 consisting of a first half-ring 20 and a second half-ring 21, associated respectively with the first sector 7 and the second sector 8.

Preferably the transmission means 17 are constrained to one of the end portion 71, 81 and the opposite end portion 72, 82, portions which, as previously described, preferably make up the first sector 7 and the second sector 8 respectively.

Moreover, the applicator device 4 is carried by a support structure 30 integral with the aforementioned transmission means, in particular to the aforementioned ring gear 19, and connected to the structure of the first sector 7 and of the second sector 8, through the interposition of rolling coupling members 31, for example wheels, arranged along respective rolling guides 32 made for each of the first sector 7 and the second sector 8.

Preferably, locking members 33 of the transmission means 17 are usefully provided, actuated by a control member 34 made up for example of a hydraulic piston, for locking the aforementioned transmission means 17, when the apparatus 1 is in a condition of rest, in particular, when the first sector 7 and the second sector 8 are in an inactive configuration, therefore open.

Conversely, when the control member 34 is deactivated for each of the first sector 7 and the second sector 8, the locking members 33 are released and allow the movement of the applicator devices 4 along a circular path around the longitudinal axis A.

The first sector 7 and the second sector 8 preferably comprise clamping means 22 to ensure the ring closure of the first sector 7 and of the second sector 8.

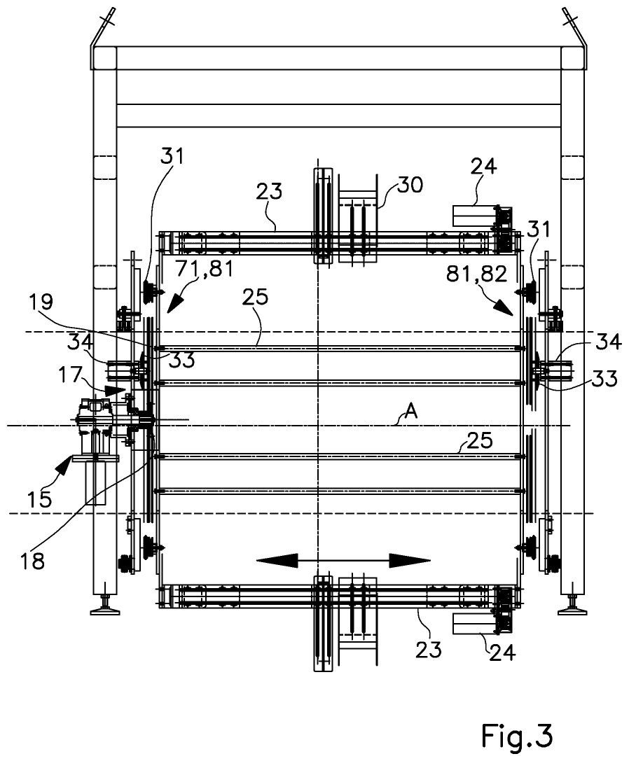

Furthermore, the applicator unit 3 comprises at least one linear guide member 23 associated with a respective actuating member 24 for moving the respective applicator device 4 along a longitudinal direction, parallel to the longitudinal axis A (see FIG. 3).

More precisely, the applicator unit 3 comprises an actuating member 24 for each applicator device 4 so that the same applicator device 4 is guided according to the aforementioned translational motion independently.

Preferably the aforementioned linear guide member 23 is made by means of a linear recirculating sphere guide. Alternatively, other types of driving are also possible, provided they are fit for the purpose.

To facilitate the guide of the applicator device 4 according to the aforesaid longitudinal direction, the applicator unit 3 comprises at least one guide rod 25, preferably a plurality of guide rods 25 (see FIG. 3).

The applicator devices 4 can fully reach the outer surface of the tubular element 2, covering it uniformly and completely, by combining the rotational motion commanded by the driving means 15 with the translational motion controlled by the aforementioned actuating members 24.

In this regard, it should be noted that, for uniform operation on the outer surface of the tubular element 2, the applicator devices 4 are preferably angularly distributed in an equidistant manner along the periphery of the first sector 7 and of the second sector 8 in the active configuration, therefore closed, for example at angular distance equal to 90°, in the case of four applicator devices 4.

It should also be noted that the applicator devices 4 can be operated either with flame only, to perform localised or distributed heating, or flame and thermoplastic powders, in order to coat the surface of the tubular element 2.

For this purpose the apparatus 1 may be further provided with temperature sensor means, for example with infrared rays, to detect the local temperature on the surface of the tubular element 2. These means may usefully be configured to send respective detection signals to the processing unit 6, so as to control in a corresponding manner the actuation of the applicator devices 4 in the heating function.

Moreover, the apparatus 1 can further include means for detecting the thickness of the coating, for example of the laser type, configured to detect the instantaneous thickness of the coating and send a respective signal to the control unit 6. The latter can in turn be usefully configured to adjust in a corresponding manner the feeding of the flow of thermoplastic powders, as well as the translatory and rotary components of the speed of the applicator devices 4 in motion around the tubular element 2.

The operation of the apparatus for flame coating tubular elements with thermoplastic powder, as well as the method implemented thereby, can be easily understood from the above description.

First of all, the tubular element 2 to be coated along the longitudinal axis A at the plant coating station is arranged.

Then, the apparatus 1 is hooked at the hooking portions 10 to the lifting means 12, raised and brought into the coating station.

More precisely, in the step of positioning the apparatus 1 the applicator group 3 is arranged in the inactive condition, therefore, in particular, with the first sector 7 and the second sector 8 in the open configuration (see FIG. 1).

Subsequently, once the frame 9 has been positioned on the tubular element 2 the applicator unit 3 is actuated by means of the positioning means 13 in the active configuration, in particular with the first sector 7 and the second sector 8 in the ring configuration arranged around, in particular coaxially to, the tubular element 2. Preferably the tubular element 2 is positioned on the ground by suitable support means, for example by at least a pair of trestles.

Preferably, the applicator devices 4 are first positioned at one end of the tubular element 2, and operated so as to ignite a respective flame, to produce localised preheating, at a given temperature, preferably between 170 and 180° C., depending on the size and diameter of the tubular element 2. At this step, by actuation of the translation means, the applicator unit 3 is preferably operated in translational movement along the longitudinal axis A to preheat the opposite end. It is also possible to divide the applicator devices 4, so that both the end portions of the tubular element 2 are as to preheated at the same time.

Then, the applicator devices 4 are also fed with thermoplastic powders and, preferably, with gases necessary for spraying and with compressed air, in order to start the coating cycle. At this step the applicator devices 4 are driven in rotational motion by the driving means 15 and according to a suitable translational motion, by the translation means, in a suitable time relationship, in order to cover the entire surface of the tubular element 2 uniformly and effectively.

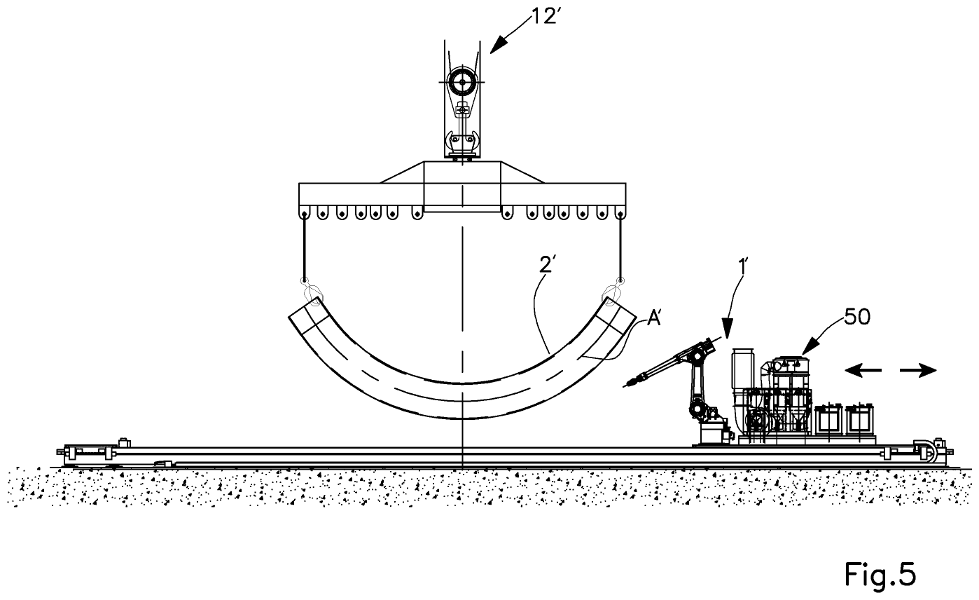

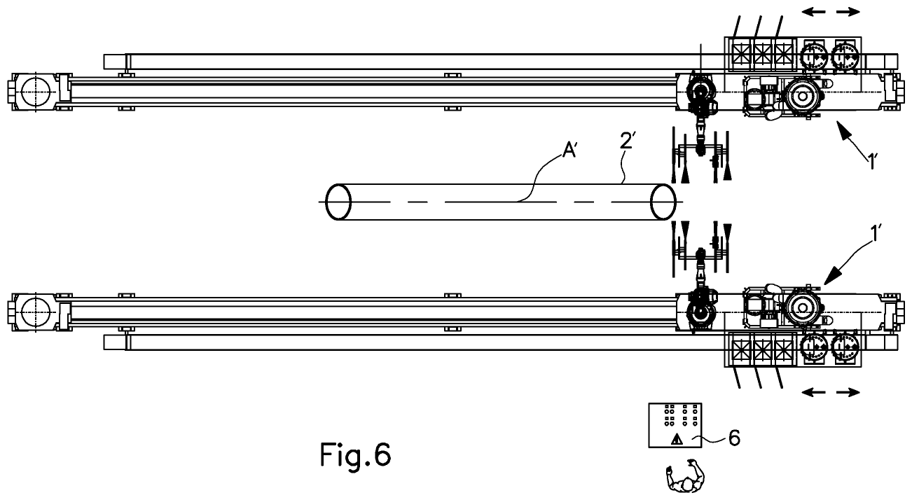

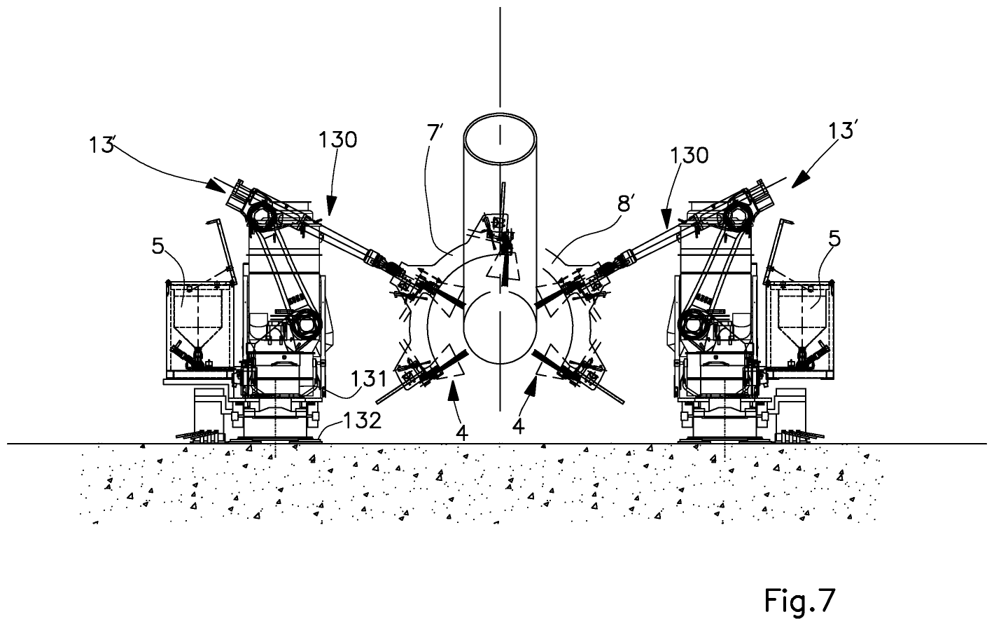

According to a further embodiment of the apparatus 1′ according to the invention, intended in particular for coating with thermoplastic powders of curved tubular elements 2′, illustrated by FIGS. 5, 6, 7, 8, 9 and 10, the applicator unit 3′ can comprise at least one sector 7′ or first sector 7′, preferably a further or second opposite sector 8′, supporting at least one respective applicator device 4.

In the embodiment illustrated as example, each sector 7′ and each further sector 8′ carries a pair of applicator devices 4, but a different number of applicator devices 4 can also be provided.

Unlike what is provided by the first illustrated embodiment, each sector 7′ and each further sector 8′ has an arc-shaped circumferential profile.

Preferably the angular arrangement of each sector 7′ and each further sector 8′ is less than 180°, since each sector 7′, as better described below, is adapted to be moved angularly to cover the entire surface of the tubular curved element 2′.

In fact, each sector 7′ and each further sector 8′ is preferably carried by positioning means 13′ in particular made by means of a respective robotic arm 130 capable of mobility on different degrees of freedom, preferably six degrees of freedom deriving from corresponding articulations, besides to a degree of freedom deriving from the possibility of longitudinal sliding of each robotic arm 130, as described in detail below.

Preferably, each robotic arm 130 is mounted on a base 131, slidable on a respective rail 132 along the longitudinal axis A′ along which the curved tubular element 2′ is positioned in the coating station of the plant, wherein the equipment 1′ is operative.

Preferably, the rails 132 on which the bases 131 run, carrying each robotic arm 130 are opposite to the longitudinal axis A′, so that the respective sectors, in particular the sector 7 and the further sector 8′, may interact with corresponding opposite portions of the outer surface of the curved tubular element 2′.

Moreover, the reservoirs 5 for containing the thermoplastic powders, together with the other necessary materials, for example polyethylene and/or polypropylene, are preferably housed on the bases 131, so that the extent of the necessary powder feeding connections is reduced.

The bases 131 also house the electrical and pneumatic supply components necessary for each applicator device 4.

On the bases 131, moreover, a suction assembly 50 is preferably positioned, connected to a series of hoods dedicated to each applicator device 4.

In the illustrated case, for example, each sector, in particular the sector 7′ and the further sector 8′, is made by means of half-rings 70, in particular four half-rings 71, 72, 73, 74 arranging in parallel, each carrying applicator devices 4, in particular spray guns.

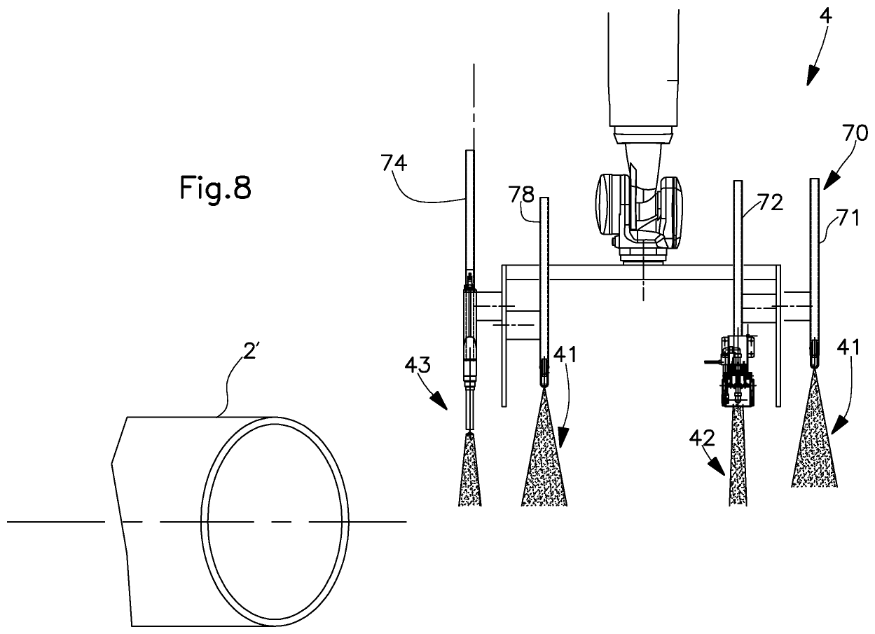

In the case illustrated as example a first half-ring 71 carries three guns 41 for the final spraying of polypropylene or polyethylene. A second half-ring 72 carries, for example, three guns 42 for flame coating, while a third half-ring 73 carries, for example, a group of three spray guns 41 for spraying polypropylene or polyethylene. Finally, a fourth half-ring 74 carries a group, preferably, of three electrostatic guns 43 for spraying FBE epoxy powder (see FIG. 8).

The provision of half-rings 70 equipped in different ways makes the use of the apparatus very versatile, in any embodiment, since it allows any type of coating to be made.

The robotic arm 130 is preferably operated so as to maintain the applicator devices 4 oriented perpendicularly with respect to the longitudinal axis A′, for an optimal coating of the tubular element 2′.

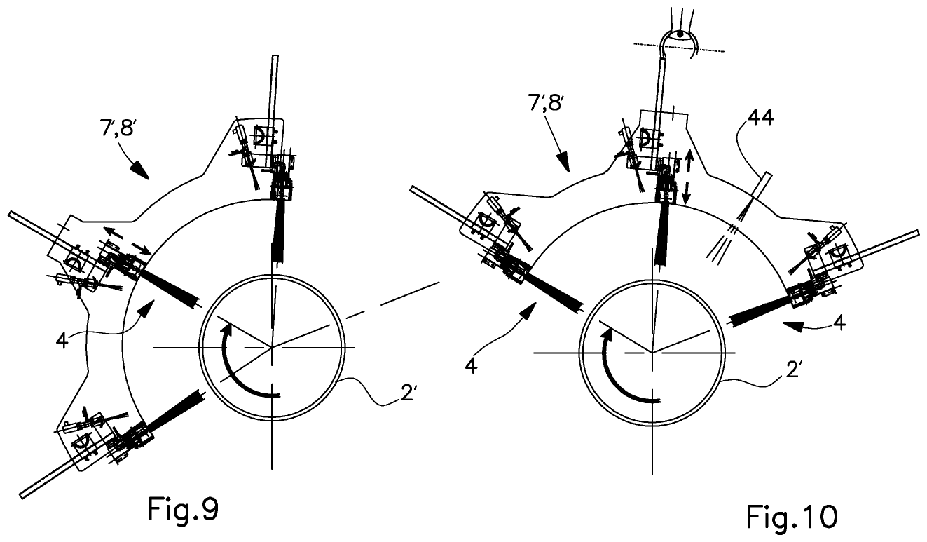

In particular, if, as in the case shown, the guns 4 are positioned at an angular distance of 65°, with a rotation of 65° operated by the robotic arm 130 around the longitudinal axis A′, it is possible to cover an arch of 195° (see FIGS. 9 and 10).

The operation of the apparatus 1′ is very similar to that described above for the first illustrated embodiment.

In particular, it should be noted that the curved tubular element 2′ is positioned along the longitudinal axis A′, which is in the curved case, in the coating station by lifting means 12′, which can be hooked to the ends of the curved tubular element 2′ itself.

Instead, the positioning of the sectors, in particular the sector 7′ and the further sector 8′, at the curved tubular element 2′ arranged in the coating station, occurs by actuating the sliding of the base 131 of the robotic arm 130 along the respective rail 132.

For the rest, the robotic arm 130 is operated upon command of the control unit 6 so that a rotary motion and/or a translational motion is produced along the longitudinal axis A′, for coating tubular element 2′.

It should be pointed out that the applicator device 4, in both embodiments, preferably in the second one, can usefully comprise temperature sensing means 44 for monitoring the temperature of the surface of the tubular element 2 or, respectively, of the curved tubular element 2′. The temperature sensor means 44 may for example consist of a pyrometer, configured to detect the surface temperature of the element, preferably in a stationary condition, between one spray and another.

The apparatus described as an example is subject to numerous changes and variations depending on the different needs.

In the practical embodiment of the invention, the used materials, as well as the shape and the dimensions, may be any according to requirements.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. Method for flame coating tubular elements with thermoplastic powders, the method comprising the steps of:
a. arranging along a longitudinal axis a said tubular element to be coated at a coating station;
b. providing an applicator unit, operating in said coating station, in an inactive configuration, said applicator unit comprising at least one sector carrying at least one movable thermoplastic powders flame applicator device and being operable alternately between said inactive condition, wherein said sector is spaced from said tubular element and an active configuration, wherein said sector is approached radially to said tubular element; said at least one applicator device being operable either with flame only, to perform localized or distributed heating, or with flame and thermoplastic powders, in order to coat the surface of the said tubular element;
c. operating in motion said applicator unit provided in said inactive configuration, towards said tubular element;
d. operating said applicator unit in said active configuration, so that said sector engages peripherally, at least partially, said tubular element;
e. commanding the activation of said at least one flame applicator device carried by said sector;
f. feeding said thermoplastic powders to said at least one applicator device; and
g. operating said sector of said applicator device, fed with said thermoplastic powders, in a rotary and/or translational motion according to said longitudinal axis so as to flame coat said tubular element with a flow of said thermoplastic powders.

2. Method according to claim 1, wherein:
said step of e. commanding the activation of said at least one flame applicator device is preceded by the step of positioning said at least one applicator device at a respective end edge of said tubular element; and
said step of f. feeding said thermoplastic powders is preceded by the step of operating said activated applicator device in rotary and/or translational motion according to said longitudinal axis, so as to heat and/or maintain said end edge at a predetermined temperature.

3. Method according to claim 1, further comprising the further step of monitoring a current data concerning the temperature of said tubular element by means of temperature detecting means during the step of g. operating said applicator device fed with said thermoplastic powders.

4. Method according to claim 1, further comprising the further step of monitoring a current data concerning a thickness of a coating layer made on said tubular element upon said step of g. operating said applicator device fed with said thermoplastic powders by means of thickness detecting means of the coating layer.

5. Method according to claim 1, further comprising controlling, by means of a processing unit at least one monitored current data, the temperature of said tubular element and/or the thickness of the coating layer made, to command the activation, maintenance and/or deactivation of said applicator device.

6. Method according to claim 1, wherein at the end of said step g. of flame coating said tubular element a further heating of said coated tubular element is carried out, by means of the controlled activation of the flame of said at least one applicator device.

7. Method according to claim 1, further comprising overlapping said step of g. operating said applicator device according to said longitudinal axis to the step of operating in motion one or more of said further applicator devices carried by said sector or by a further sector of said applicator unit, to coat said tubular element.

8. Apparatus for flame coating tubular elements with thermoplastic powders, the apparatus comprising an applicator unit operating in a coating station at which one said tubular element is arranged along a longitudinal axis, said applicator unit comprising at least one sector carrying at least one movable thermoplastic powders flame applicator device and being operable alternately between an inactive configuration, wherein said sector is spaced from said tubular element and an active configuration, wherein said sector is approached radially to said tubular element provided in said coating station, said sector being operable in a rotary and/or translational motion according to said longitudinal axis, so as to flame coat said tubular element with a controlled flow of said thermoplastic powders; said at least one applicator device being operable either with flame only, to perform localized or distributed heating, or with flame and thermoplastic powders, in order to coat the surface of the said tubular element.

9. Apparatus according to claim 8, further comprising temperature detecting means associated with said sector, for measuring the current temperature of said tubular element during the coating step.

10. Apparatus according to claim 9, wherein said temperature detecting means comprises infrared sensors.

11. Apparatus according to claim 8, further comprising thickness detecting means for a coating made by means of said at least one applicator device on said tubular element, associated with said sector.

12. Apparatus according to claim 11, wherein said thickness detecting means comprises a laser device.

13. Apparatus according to claim 9, wherein said sector carries at least one further said applicator device.

14. Apparatus according to claim 13, wherein said applicator device and said at least one further applicator device are radially distributed around said longitudinal axis in said active configuration.

15. Apparatus according to claim 8, wherein said applicator unit comprises said sector as a first sector and a second sector, each carrying at least one movable applicator device.

16. Apparatus according to claim 15, wherein said first sector and said second sector are hinged to one another so as to mutually rotate around a respective hinging axis between said inactive, open configuration, and said active, closed ring configuration around said longitudinal axis.

17. Apparatus according to claim 16, wherein at least one of said first sector and said second sector carries a motor member, said motor member operating said at least one rotating applicator device by means of an interposing transmission means.

18. Apparatus according to claim 8, wherein said applicator unit is carried by a frame carrying at least one hooking portion for hooking lifting means.

19. Apparatus according to claim 8, wherein said sector of said applicator unit is carried by a robotic arm able of moving on different freedom degrees for coating said curved tubular element around said longitudinal axis.
